(19) United States
(12) Patent Application Publication
(10) Pub. No.: US 2008/0156276 A1
(43) Pub. Date: Jul. 3, 2008

(54) Portable den

(76) Inventors: Sagi Denenberg, Afula (IL); Fabian Trumper, Afula (IL)

Correspondence Address: Kathleen R. Terry, 1666 Coffman Street #314, Falcon Heights, MN, 55108, US

(21) Appl. No.: 11/646,867

(22) Filed: Dec. 28, 2006

(51) Int. Cl. A01K 1/03

(52) U.S. Cl. 119/514; 119/513

(57) ABSTRACT

The invention is a portable den for dogs which is divided into a sleeping/feeding area and a litter area. This internal division, allows a puppy to avoid contact with the litter area except to relieve itself the dog's natural instinct to avoid soiling its den is reinforced. The portable den is fully collapsible for travel or storage.

### FIELD OF THE INVENTION

This invention relates to dens and carrying devices for animals, in particular for dogs. The invention also relates to the training of puppies.

### BACKGROUND OF THE INVENTION

The care and training of dogs is most successful and less stressful both for the dog and the owner when based on the natural instincts of the dog. A strong instinct is that of the den. Dogs are most relaxed when in an enclosed area that simulates the den of its ancestor, the wolf. The dog will keep its den clean, that is, it will not soil its sleeping place if it has an alternative. Many dens or kennels are available to house a dog in today's urban environment. An outside kennel with an exercise area and a “dog house” may well approximate a dog's preferred environment. However, many dogs must be kept inside in dens and left alone for long periods of time. It is difficult for any dog, but especially for puppies, to keep the den clean. When traveling, the dog must leave its familiar area, which can be disturbing to the dog.

### SUMMARY OF THE INVENTION

The inventors of this inventions have solved the aforementioned shortcomings of available devices by inventing a portable den that separates litter area from sleeping and eating area, while being compact and portable. In the following description, it should be understood that “down” or “lower” refers to the direction toward the base unit, that is, the part resting on a floor; “up” or “upper” refers to the direction away from a floor; “front” refers to the area comprising an entrance door; “back” refers to the area farthest from the entrance.

The den consists of:
1. A base unit forming the floor of the den;
2. An upper frame;
3. Two side walls foldably attached at the lower edge to the base unit and at the upper edge to the upper frame, each wall having a center fold;
4. A back wall foldably attached at its upper edge to the upper frame;
5. A front wall foldably attached to the upper frame, the front wall comprising and entrance opening; and
6. An interior wall foldably attached to the base unit, the interior wall having an opening.

When folded for carrying, the sides walls fold at their centers, the front wall is folded up and the back wall is folded up, both walls resting on the base unit when the den is collapsed. The interior wall is folded down onto the base unit, thus collapsing the den to a compact size. When expanded, the upper frame is raised, causing the side walls to unfold and rise; the front wall is folded up and is secured in place; the back wall is folded down to meet the base unit and is secured in place; the interior wall is raised to separate the back litter area from the front sleeping/feeding area.

The den is preferably fitted with a feeding dish, which may be triangular in shape and fitted into a corner of the sleeping area. A litter box may be placed in the litter area to receive pads or litter. Windows may be cut into the walls, if desired. In the preferred arrangement of the interior, the sleeping/feeding area is located just inside the entrance at the front of the den, while the litter area is behind the interior wall at the back of the den.

### BRIEF DESCRIPTION OF THE DRAWINGS

FIG. 1 shows a top view of the invention as expanded.

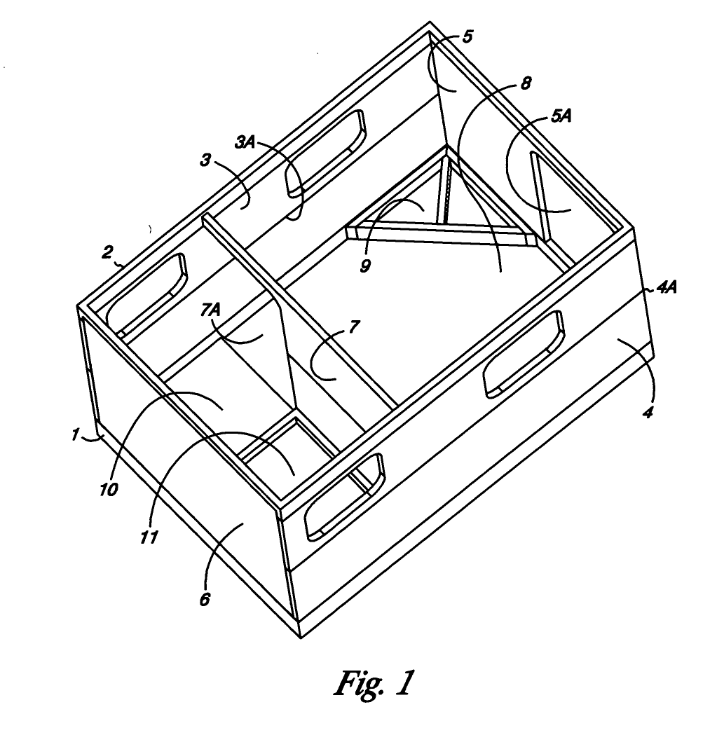

FIG. 2 shows a top view of the invention as collapsed.

FIG. 3 shows a front view of the den fully expanded, with the front wall tilted to show the interior.

FIG. 4 shows a back view of the den fully expanded, with the back wall tilted to show the interior.

### DETAILED DESCRIPTION OF THE INVENTION

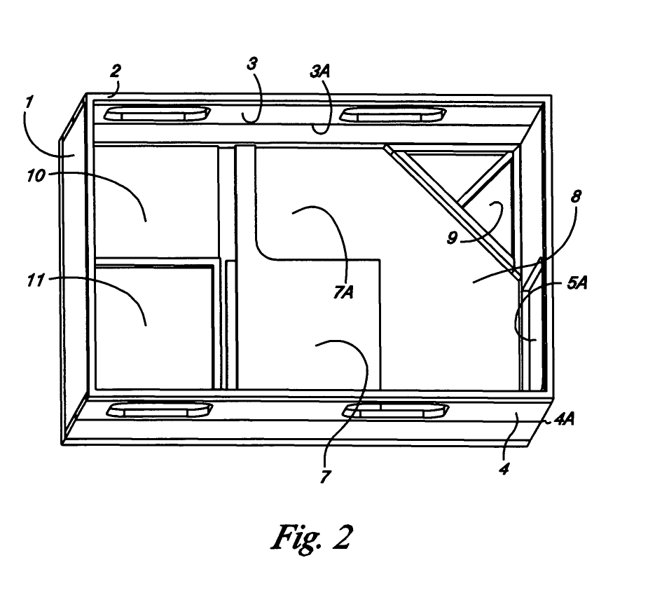

FIG. 2 is a top view of the expanded den. The base unit 1 and the upper frame 2 are shown. The side walls 3 and 4 are unfolded to reveal the center folds 3A and 4A of each. The front wall 5 with entrance 5A is folded down from its attachment to the upper frame. The back wall 6 is likewise folded down from its attachment to the upper frame. The interior wall 7 with opening 7A is folded up from its attachment to the base unit. The sleeping/feeding area 8 is placed just inside the entrance 5A, with the feeding dish 9 placed in a corner. The litter area 10 and litter box 11 are placed at the back.

Turning to FIG. 2, the top view of the collapsed den shows the base unit 1, the upper frame 2, with side wall 3 with center fold 3A and side wall 4 with center fold 4A extending between the base unit 1 and the upper frame 2. The interior wall 7 is shown folded down and 7A rests on the base unit 1. Also shown are the sleeping/feeding area 8, the feeding dish 9 and the litter area 10 and litter box 11.

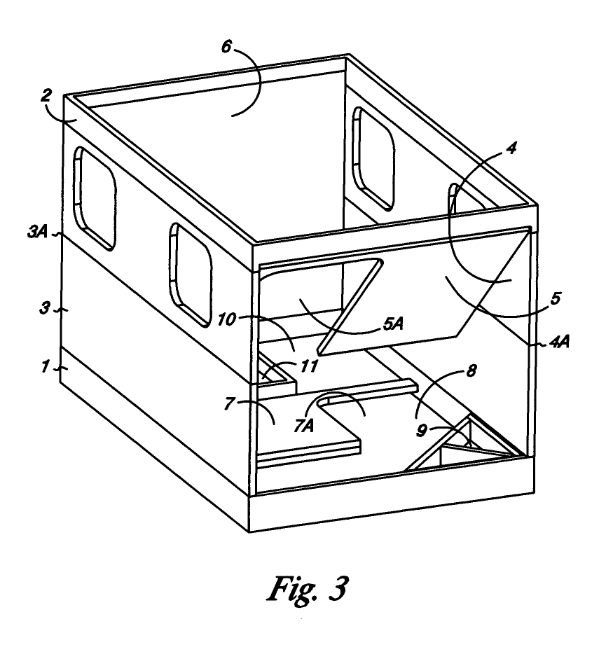

FIG. 3 is a front view of the expanded den with the front wall 5 with door 5A partially raised to show the interior of the den. Base unit 1, upper frame 2, back wall 6, side wall 3 with center fold 3A, side wall 4 with center fold 4A, interior wall 7 with door 7A, sleeping/feeding 8 area with feeding dish 9, litter area 10 with litter box 11 are shown.

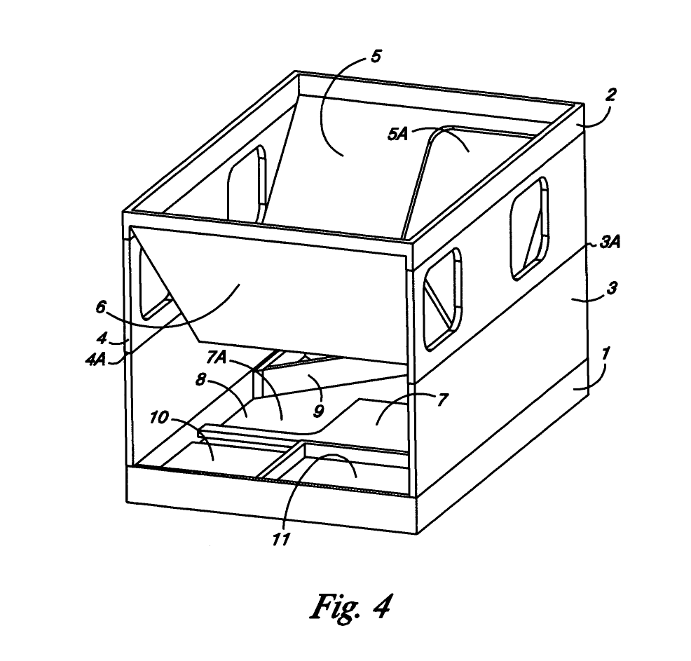

FIG. 4 is a back view of the expanded den with the back wall 6 partially raised to show the interior. Base unit 1, upper frame 2, front wall 5 with door 5A, side wall 3 with center fold 3A, side wall 4 with center fold 4A, interior wall 7 with door 7A, sleeping/feeding 8 area with feeding dish 9, litter area 10 with litter box 11 are shown.

The den is an effective, safe and humane tool that is designed to help owners of new puppies with their house training, which is often a long and frustrating task, especially for novice owners. While the puppy is born with an instinct to keep its den clean, it can extinguish this instinct when the den does not permit it to separate sleeping/eating from relieving itself. Worse, in a large “den” such as a house, the puppy may identify a living area as its litter area and continue to relieve itself in that spot, often to the distress of the owner. The den of this invention has an internal wall for division into two compartments, the sleeping/feeding area and the litter area. Due to this internal division, the puppy need not come in contact with the litter area except to relieve itself; thus the dog's natural instinct to avoid soiling its den is reinforced. This reinforced instinct will transfer over to the home as a whole, achieving nearly automatic house training. The litter area is best provided with a tray that is easily removed and of a size to receive a “puppy pad”, newspapers, or litter. In the living/sleeping area, the food and water bowls are best attached at the corners to avoid spillage as the puppy moves around.

In normal use, the entrance is open to allow the puppy freedom to come and go within a restricted area of the home, generally the bathroom or kitchen. Not shown is a door closing the entrance, when it is desirable to confine the puppy. When the puppy is in the den, it can have toys and be left alone when the owners are not home or at night. Owners must be reminded that the den is not a substitute for daily walks and training, but it improves house training when the owner is not around.

Past the puppy stage, the den continues to be useful as a retreat for napping and a place for the litter box. When the dog or puppy is taken on a trip or the unit is to be stored, the unit can be folded into a compact unit and easily reassembled simply by pulling on the upper frame while holding the base unit, until the side walls unfold and are fully erected. Then the front and back walls are pushed into place from the inside out, finally pulling the interior wall upward and locking it into place. The easy collapsibility and expansion of the unit give the dog or puppy a larger area in which to remain than the carrier dens now available, while taking up minimal storage room when the puppy is not confined inside.

Any suitable materials may be used. The most preferable materials are stiff, impermeable plastics such as polyethylene, polypropylene, or fiberglass. The center fold may be fitted with hinges made of plastics, such as nylon or polypropylene, or may be metal. When the center fold comprises rigid hinges, it is preferred that the hinge self lock on expansion. If the center fold comprises a soft, non-rigid material, a locking means may be inserted in the upper frame to hold the den in an expanded mode. The locking means may be a simple latch that can be rotated from a slot in the upper frame to extend downward.

The den made be made in several sizes. In general, for smaller puppies and dogs up to about 25 kilograms, a base unit measuring 75×50×50 cm (length, width, height) is adequate. A larger puppy or dog over 25 kilograms will be more comfortable in a den measuring 90×60×60.

Those skilled in the art may readily make additions or substitutions to the portable den in order to customize the den to suit individual tastes. Such additions or substitutions are considered to be within the scope of the appended claims.

We claim:

1. A den comprising:
(a) base unit forming the floor of the den;
(b) an upper frame;
(c) two side walls foldably attached at the lower edge to the base unit and at the upper edge to the upper frame, each wall having a center fold;
(d) a back wall foldably attached at its upper edge to the upper frame;
(e) a front wall foldably attached to the upper frame, the front wall having an entrance opening; and
(f) an interior wall foldably attached to the base unit, the interior wall having an opening.

2. The den of claim 1 further comprising at least one window in at least one side wall.

3. The den of claim 1 further comprising the center folds comprised of a self-locking rigid material.

4. The den of claim 1 further comprising the center folds comprised of a non-rigid material and the upper frame comprising a locking means.

5. A portable den comprising:
(a) base unit forming the floor of the den;
(b) an upper frame;
(c) two side walls foldably attached at the lower edge to the base unit and at the upper edge to the upper frame, each wall having a center fold, the side walls being folded;
(d) a back wall foldably attached at its upper edge to the upper frame, the back wall being folded up;
(e) a front wall foldably attached to the upper frame, the front wall having an entrance opening, the front wall being folded up; and
(f) an interior wall foldably attached to the base unit, the interior wall having an opening, the interior wall being folded down.
wherein the portable den is collapsed.
